(19) United States
(12) Patent Application Publication
(10) Pub. No.: US 2012/0060000 A1
(43) Pub. Date: Mar. 8, 2012

(54) SYSTEM AND METHOD FOR FLEXIBLY STORING, DISTRIBUTING, READING, AND SHARING ELECTRONIC BOOKS

(76) Inventor: Guozhong Zhu, Zhuhai (CN)

(21) Appl. No.: 12/876,187

(22) Filed: Sep. 6, 2010

(51) Int. Cl. G06F 3/048; G06F 12/00

(52) U.S. Cl. 711/154; 715/776; 711/E12.001

(57) ABSTRACT

An electronic book card includes a communication interface that can communicate with a host reading device having a display device configured to display images in a display configuration. The communication interface can receive the display configuration from the host reading device. A non-volatile memory can store content of an electronic book. A data processing unit can generate page images in accordance with the display configuration of the display device. The page images incorporate the content of the electronic book.

### BACKGROUND OF THE INVENTION

The present disclosure relates to technologies for distributing and sharing of electronic books.

Electronic books have become a popular way of book reading in recent years. An electronic book is a digital document carrying the content of a conventionally printed book. The current electronic books convert the content of the printed books into special electronic formats. Electronic books are often sold to consumers via the Internet. The consumers can read the electronic books on dedicated devices known as e-book readers which are compatible with the special electronic formats. Some electronic books can be read on computers and mobile phones installed with proprietary software.

The current e-book readers and the ways of distributing electronic books include several drawbacks: first, copyrights are not appropriately protected. Secondly, the interests of the author, the publisher, the distributor, and the e-book reader manufacturers are not properly divided. Thirdly, the e-book readers are expensive and dedicated to a single use. The cost is too high for users who only infrequently read a small number of books. Moreover, electronic books are commonly distributed via the Internet. There are very few alternatives for readers to obtain electronic books. Furthermore, readers who purchased copyrighted electronic books cannot conveniently share the book content with others.

There is therefore a need for electronic books free of the above described drawbacks.

### SUMMARY OF THE INVENTION

The present application discloses a simplified approach for storing, distributing, facilitating reading, and sharing electronic books. The disclosed apparatus and methods allow electronic books to be stored in pluggable memory devices that have standard interfaces (e.g. SD card, USB, etc.) that people are already familiar with. The disclosed electronic books can be easily stored, distributed, and carried around on these memory cards. The electronic book cards can be implemented in compact sizes that are easy to carry around and shared.

Unlike some conventional systems, the disclosed systems and methods for electronic books do not require dedicated hardware devices: they can be read on any electronic device that includes standard interfaces with the memory cards. Examples of suitable devices include image frames, desktop, laptop, and tablet computers, mobile phones, and e-book readers. The book page images are dynamically generated according to the configurations of the display device on the hosting reading device.

The electronic book cards can be provided at low costs to the users and read on multi-purpose electronic devices such as computers and image frames. The users can significantly same cost per electronic book compared to dedicated e-book readers.

Unlike some conventional systems, the disclosed electronic books do not require the installation of special software applications or drivers on the host electronic devices. The book pages are dynamically produced in standard image formats such as BMP, RAW, JPEG, TIFF, GIF, PNG, etc., which do not need to be decoded by special proprietary software.

Another advantage of the disclosed systems and methods is that the disclosed electronic books can easily be distributed and shared in physical forms similar to physical books, in the form of pluggable memory cards. The electronic book cards can be easily sold at retail or online stores.

Moreover, the disclosed systems and methods can properly provide copyright protection to electronic books. The content of an electronic book is dynamically created specific to the format and resolution of the reading device but is not stored in page layouts, which prevents illegal copying from the memory cards. Intelligence and prevention methods can be implemented in the micro controller unit in the disclosed memory cards to make is non-economical and unappealing for unauthorized use of the images for of book pages.

In a general aspect, the present invention relates to an electronic book card that includes a communication interface configured to communicate with a host reading device having a display device configured to display images in a display configuration, wherein the communication interface can receive the display configuration from the host reading device; a non-volatile memory configured to store content of an electronic book; and a data processing unit in communication with the communication interface and the non-volatile memory, wherein the data processing unit can generate page images in accordance with the display configuration of the display device, wherein the page images incorporate the content of the electronic book.

Implementations of the system may include one or more of the following. The data processing unit can dynamically generate page images in accordance with the resolution of the display device on the host reading device. The content of the electronic book is not stored in page layouts in the non-volatile memory. The data processing unit can superimpose a background image on the content of the electronic book to produce the page images. The background image can include at least one of dots, textures, or wavy lines. The content of the electronic book can include at least one of text, a figure, or a table. The electronic book card can further include a non-volatile memory controller configured to retrieve the content of the electronic book from the non-volatile memory. The electronic book card can further include a micro controller core configured to control the communication among the communication interface, the non-volatile memory controller, and the data processing unit. The electronic book card can further include a micro controller unit that integrates the data processing unit, the non-volatile memory controller, and the micro controller core in an integrated circuit. At least one of the communication interface or the non-volatile memory can be embedded in the micro controller unit. The data processing unit can automatically receive the configuration of the display device from the host reading device after the communication interface establishes communication with a host reading device having a display device. The data processing unit can send a plurality of sample page images to the host reading device, each sample image compatible with a different display configuration, wherein the display device on the host reading device can display the plurality of sample page images to allow a reader to select one of the sample page images having display configuration suitable for the display device, wherein the data processing unit can generate the page images in response to the sample image selected by the user. The communication interface can be compatible with a standard selected from Secure Digital (SD) card, universal standard bus (USB) memory stick, CompactFlash card, SmartMedia card, Memory Stick, and Multimedia Card. The host reading device can include an image frame, a desktop computer, a laptop computer, a tablet computer, a mobile phone, a GPS receiver, a gaming machine, or an electronic book reader.

In another general aspect, the present invention relates to a method for providing electronic books that includes storing content of an electronic book in a non-volatile memory in an electronic book card; establishing communication between a communication interface in the electronic book card and with a host reading device, wherein the host reading device comprises a display device configured to display images in a display configuration; receiving the display configuration by the communication interface from the host reading device; generating page images by a data processing unit in the electronic book card in accordance with the display configuration, wherein the data processing unit is configured to incorporate the content of the electronic book in the page images; and sending the page images from the electronic book card to the host reading device through the communication interface to allow the page images to be displayed on the display device.

Implementations of the system may include one or more of the following. The method can further include dynamically generating page images by the data processing unit in accordance with the resolution of the display device. The content of the electronic book can be not stored in page layouts in the non-volatile memory. The step of generating page images can include superimposing a background to the content of the electronic book to produce the page images. The method can further include automatically receiving the configuration of the display device by the data processing unit from the host reading device after the step of establishing communication. The method can further include sending a plurality of sample page images from the electronic book card to the host reading device, each sample image compatible with a different display configuration to display the plurality of sample page images; allowing a reader to select one of the sample page images having display configuration suitable for the display device and generating the page images in response to the sample image selected by the user. The communication interface can be compatible with a standard selected from Secure Digital (SD) card, universal standard bus (USB) memory stick, CompactFlash card, SmartMedia card, Memory Stick, and Multimedia Card.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIG. 1 is a block diagram for an electronic book system in accordance with the present invention.

FIG. 2A is an exemplified block diagram for an electronic book card compatible with FIG. 1.

FIG. 2B is a control flow diagram for the micro controller shown in FIGS. 1 and 2A.

FIG. 3 is a block and flow diagram for another configuration of an electronic book card compatible with FIG. 1.

FIGS. 4A and 4B illustrate page images produced for two different display configurations.

FIG. 5A illustrates the exemplified content in a page of an electronic book.

FIG. 5B illustrates an example of a background image containing a high frequency pattern.

FIG. 5C illustrates a page image formed by superimposing the text content shown in FIG. 5A and the background image in FIG. 5B.

FIG. 6 is a flowchart for the providing the electronic books in accordance with the present invention.

### DETAILED DESCRIPTION OF THE INVENTION

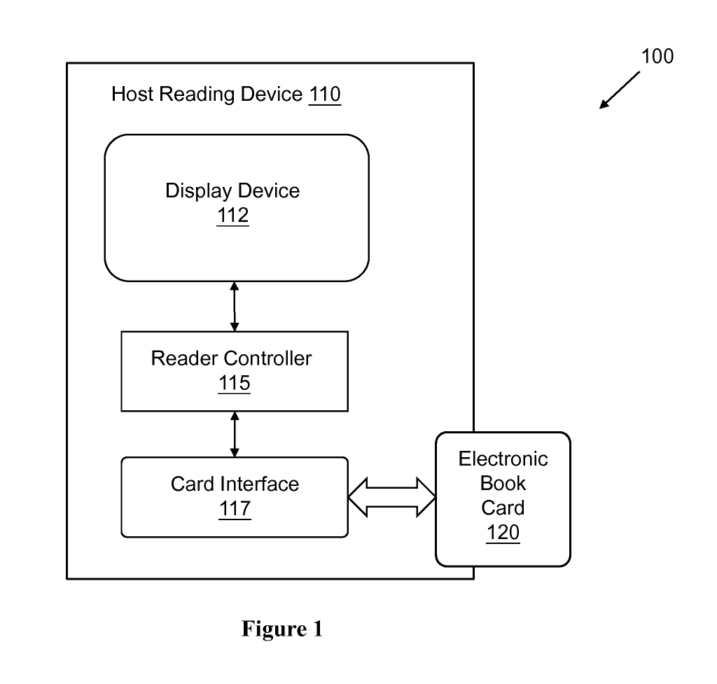

Referring to FIG. 1, an electronic book reading system 100 includes a host reading device 110 and an electronic book card 120. The host reading device 110 includes display device 112, a reader controller 115, and a card interface 117. The display device 112 can be based on reflective (such as the E-Ink), Liquid Crystal (LC), and Organic Light Emission Diode (OLED) technologies, and can be provided in various sizes and formats suitable for book reading. The reader controller 115 prepares data for the display device to display book pages and control information for navigating within a book or across different books. The reader controller 115 also communicates with the card interface 117.

The card interface 117 can include any standard interfaces for non-volatile memory cards, which can include Secure Digital (SD) card, universal standard bus (USB) memory stick, CompactFlash card, SmartMedia card, Memory Stick, Multimedia Card, etc. The SD cards can include different variations such as SDHC (High Density) card, SDXC (eXtended Capacity) card, miniSD card, and MicroSD cards, etc. The electronic book card 120 has an interface and a form factor as defined by the specifications of a standard memory card.

The host reading device 110 can include any electronic devices that have standard interfaces for memory cards and can display images in standard image formats. Examples of suitable devices include image frames, desktop computers, laptop computers, tablet computers, mobile phones, GPS receivers, gaming machines, e-book readers, etc.

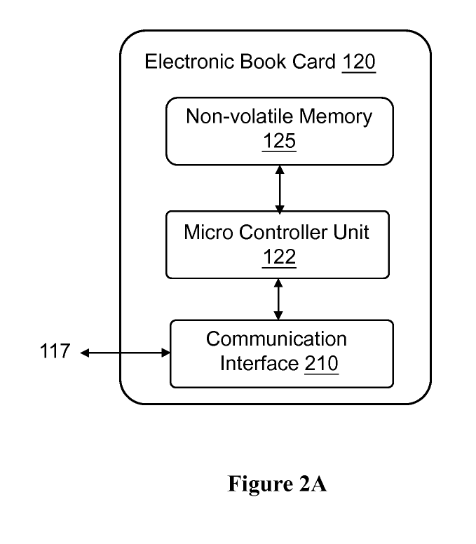

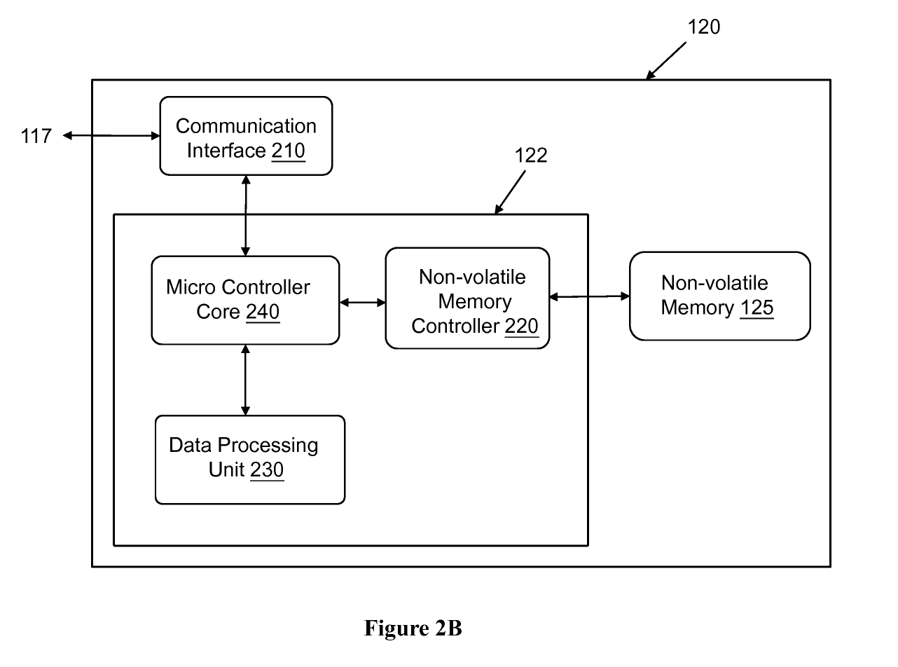

In accordance with the present invention, referring to FIG. 2A, the electronic book card 120 includes a micro controller unit 122, a non-volatile memory 125, and a communication interface 210 configured to communicate with the card interface 117 in the host reading device 110. The non-volatile memory 125 can store content of one or more electronic books. The content of an electronic book can include text, figures, tables, author information, publishing and copyright information, etc. The non-volatile memory 125 can be implemented as read only memory (ROM) such as Mask ROM, Electrically Erasable Programmable Read Only Memory (EEPROM), one-time programmable (OTP) memory, or flash memory.

The reader controller 115 can send the configuration of the display device 112 and data requests to the electronic book card via the card interface 117. The micro controller unit 122 can retrieve the text and other information in the electronic book from the non-volatile memory 125 and produces page images as required by the display device 112. The page images are sent to the reader controller 115 through the card interface 117. The reader controller 115 enables the page images to be displayed on the display device 112.

An important feature of the electronic book reading system 100 is that the whole content of an electronic book is not pre-stored and ready to be retrieved in the form of page layouts 5 in the non-volatile memory 12. Instead, as described below, page images are dynamically created after the configuration of the display device 112 is received by the electronic book card 120. The content (text, figures, tables, etc.) for the electronic books can be stored in the non-volatile memory 125 in encrypted format that is accessible to the micro controller unit 122 but cannot be copied to the host reading device 10.

Although the form factor and the interface of the electronic book card 120 are defined by the specifications of a standard memory card, it should be noted that the electronic book card 120 includes integrated circuit (IC) and intelligence that are not present in standard memory cards. Specifically, the micro controller unit 122 is configured to prepare page images for each specific host reading device.

Referring to FIG. 2B, the micro controller unit 122 includes a non-volatile memory controller 220, a data processing unit 230, and a micro controller core 240. The communication interface 210 is in compliance with the standard specifications of the card interface 117. The communication interface 210 can receive operation commands and the configuration of the display device 112 from the hosting reading device 110. The communication interface 210 can also send data related to the electronic book to the hosting reading device 110 as requested. The non-volatile memory controller 220 can decrypt the data stored in the non-volatile memory 125 to extract the data related to the electronic book. The data can include book content in text or image forms, author's information, the publisher's information, copyright information, ISBN, etc. The encryption of the book information can be proprietary. The non-volatile memory controller 220 can also receive comments, bookmarks from the host reading device 110 and write the information in the non-volatile memory 125.

The micro controller core 240 controls the data flow among the communication interface 210, the non-volatile memory controller 220, and the data processing unit 230. After the electronic book card 120 is plugged into the host reading device 110, the communication interface 210 can automatically receive the configuration of the display device 112 from the host reading device 110. The configuration can include dimensions, the resolution (e.g. 800×600 pixels), the bit depth (i.e. the number of bits per pixel), font types for the characters, gamma, tone scale, and color profiles, etc.

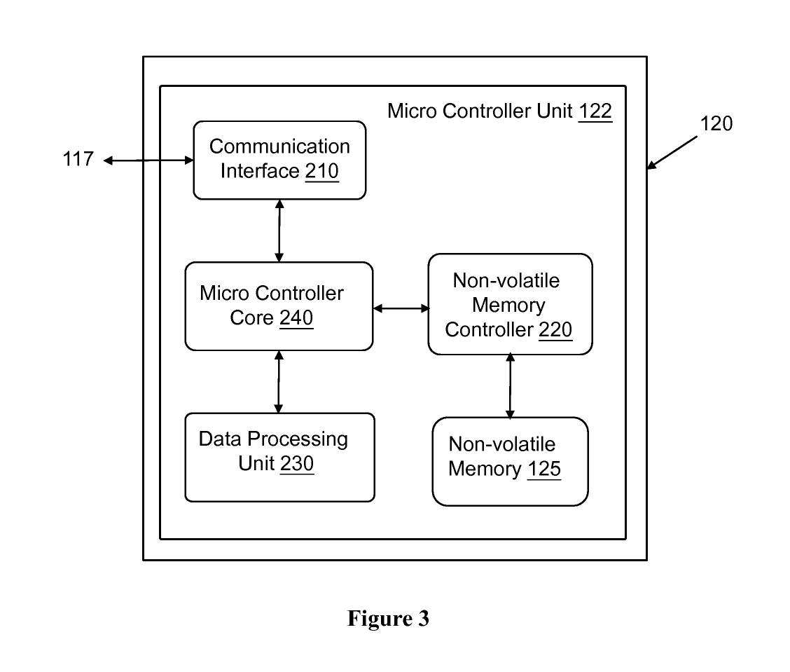

The communication interface 210 can be a separate circuit or integrated as a part of the micro controller unit 122. The non-volatile memory 125 can be implemented as a separate circuit or embedded in the micro controller unit 122. In some embodiments, referring to FIG. 3, the communication interface 210 and the non-volatile memory 125 are integrated in the micro controller unit 122. Alternatively, one of the communication interface 210 and the non-volatile memory 125 can be embedded in the micro controller unit 122 while the other one is separate from the micro controller unit 122.

In some embodiments, the micro controller core 240 in the electronic book card 120 can send a plurality of sample page images at different resolutions to the reader controller 115. The sample images can be dynamically produced by the data processing 230 using the content (e.g. first page) of the electronic book to be displayed. Alternatively, the sample images can be pre-stored using unrelated text information. The reader controller 115 can display these sample page images on the display device 112 for the user to manually pick one that is most suitable for her reading. The user selection can be based on the size, the resolution of the display device 112 as well as her personal preference. For example, different users may prefer large or smaller fonts for the same display device.

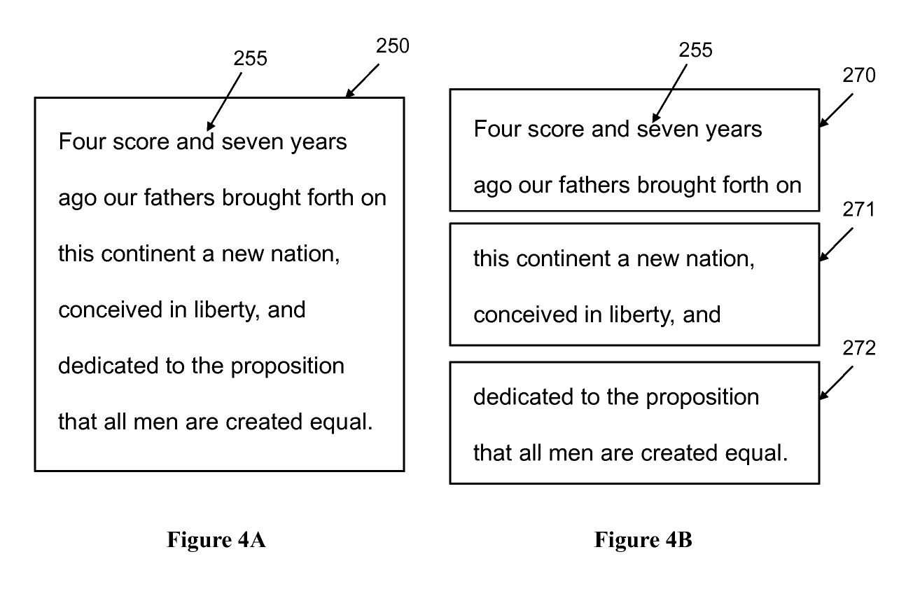

The data processing unit 230 can create page images using the book content stored in the non-volatile memory 125 and in accordance to the display configuration received by the communication interface 210. The page images are correctly sequenced according to the book content. The number of characters in each page is dynamically adjusted according to the resolution and dimensions of the display device 112 to allow the reader comfortably discern text on page pages on the display device 112. For example, the data processing unit 230 can create page images 250 having about 300 characters per page for a display device having 800×600 pixels, as shown in FIG. 4A (the number of characters is reduced for illustration purpose). For a mobile phone having a much smaller display screen of 400×300 pixels, the data processing unit 230 may create page pages 270-272 having 100 characters per page image, as shown in FIG. 4B (the number of characters is reduced for illustration purpose). A significant feature of the presently disclosed system and the methods is that the number of pages for an electronic book is dependent on the page layout that the data processing unit 230 selects in response to the display configuration of the display device 112. For example, an electronic book may contain 500 pages with 300 characters per page for the display device having 800×600 pixels. The same electronic book may be 1500 pages long with 100 characters per page for the display device having 400×300 pixels. As shown in FIGS. 4A and 4B, for the same content 255, three page images 270-272 are produced by the data processing unit 230 for the display device with fewer pixels while only one page image 250 is produced for the display with more pixels.

An advantage of the presently disclosed electronic book reading system is the dynamic adjustment of the page content and the number of pages. The conventional electronic books are preprocessed in the form page images at one or multiple resolutions. For electronic books in pdf format, the user can scale the size of a book page to different sizes, but the number of characters per page and the number of pages are fixed. For dedicated e-book readers, the resolutions are fixed and known to the proprietary system; book pages can thus be prepared at one or more resolutions ahead of the time. A disadvantage of pre-processed book pages is that they are vulnerable for being illegally copied.

Another feature of the electronic book reading system 100 is that page images produced by the data processing unit 230 have standard image formats, such as BMP, RAW, JPEG, TIFF, GIF, PNG, etc., which do not need to be decoded by special proprietary software. The page images can be read and displayed by any type of display devices without installation of special software applications or drivers on the host electronic device 110. For example, an image frame for displaying family images on a desk top can be used to as the host reading device 110 in accordance to the present invention. After the electronic book card 120 is plugged into the card slot (e.g. for a SD card or a USB stick), the display configuration of the image frame is communicated to the electronic book card 120. The data processing unit 230 can prepare page images in correct sequence according to the display configuration. The micro controller core 240 can send the page images to the image frame via the communication interface 210. The image frame can display the page images similar to the way that the image frame displays photographic images. A user can use the arrow buttons to browse different pages.

It should be noted that although page images are provided in standard image formats from the electronic book card 120 to the host reading device 110, the dynamically created page images are limited to the specific configurations of the display device for that reading event. An authorized user cannot reproduce the functions of the electronic book card 120. Even if the page images were copied by the authorized user, the page images will not correctly display at the appropriate size and resolution on different display devices. Moreover, the page images will not be sequenced correctly as enabled by the data processing unit 230 and the micro controller core 240.

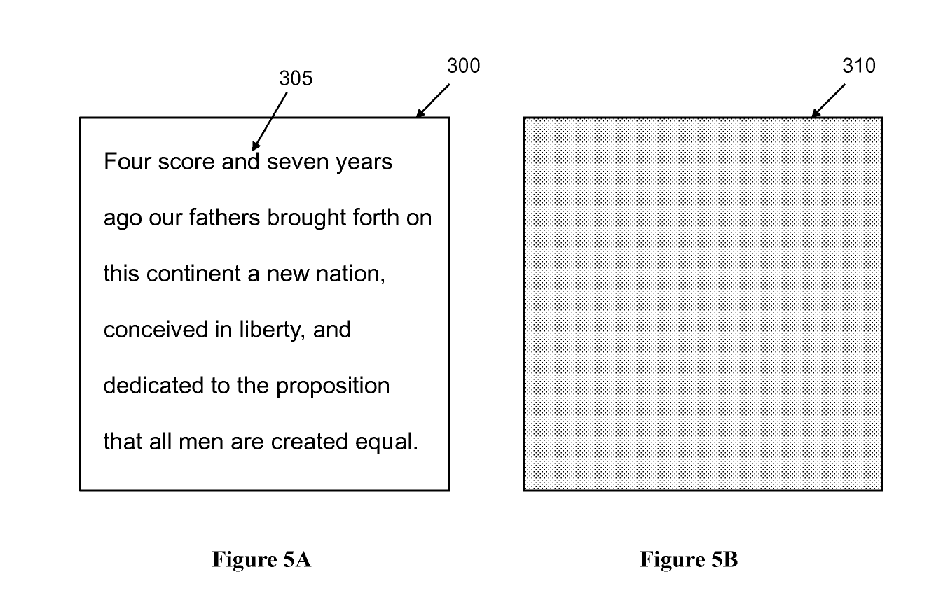

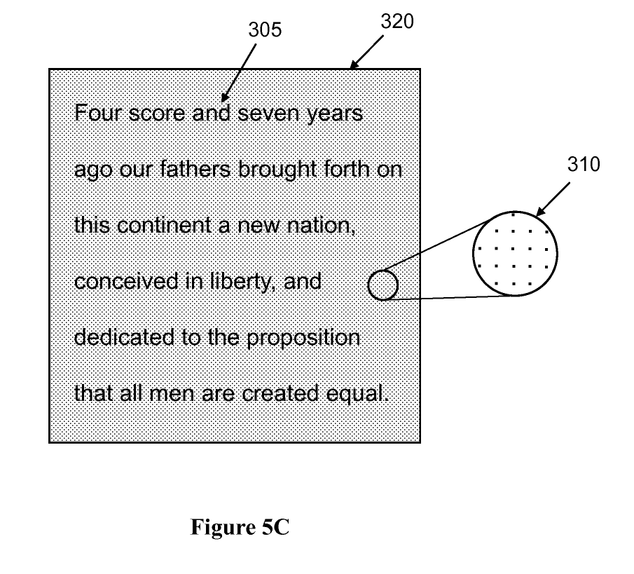

In some embodiments, the disclosed system and methods provide barriers to the illegal copying and usage of the page images. Referring to FIGS. 5A-5C, a dynamically created page image 300 of an electronic book includes page content 305 (such as text, figures, tables, etc.). The non-volatile memory 125 can store one or more background images 310 which have high frequency patterns such as textures, dots, wavy lines. Alternatively, the background images can be dynamically created by the data processing unit 230. The page content 305 and the background image 310 are superimposed by the data processing unit 230 to produce a processed page image 320 which is sent from the electronic book card 120 to the host reading device 110 for display. The high frequency patterns in the background image 310 cannot be discerned by user's eyes and thus only provides the perception of a uniform background. The background image 310 can be customized to provide light grey, light green or light blue etc. to provide aesthetically appealing colors and reduce eye fatigue. The pattern may be periodically or non-periodically distributed. The high frequency pattern is used to make it difficult for the illegal use and compressions of the page images 320. Without the background image 310, the page image 300 has vast majority areas being white and thus with zero pixel values. The page image 300 can easily be compressed with high compression ratio. For example, a page image of 800×600 pixels can have a size of 1.4 MByte in BMP format, which can be compressed down to about 140 Kbytes in JPEG. In contrast, the processed page image 320 having the high frequency pattern in the background can only be compressed at much lower ratios to about 0.5 Mega Byte. The processed page image will suffer significant degradation in image quality at higher compression ratios.

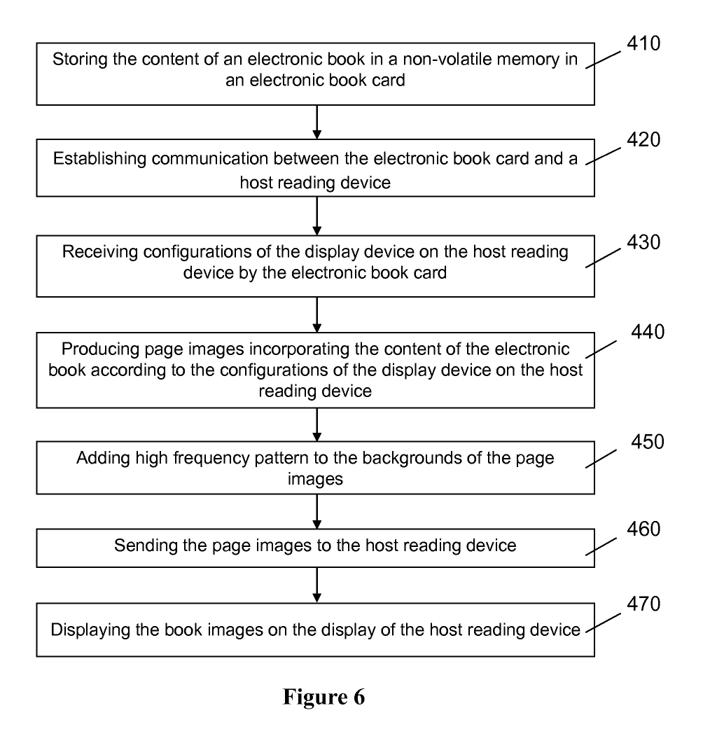

A process for providing electronic books is shown in FIG. 6. The content of an electronic book is first stored in a non-volatile memory in an electronic book card (step 410). The content of the electronic book can include text and Figures, author and publishing information. The content is not stored in page layouts. Communication between the electronic book card and a host reading device is established when the electronic book card is plugged into a card slot on the host reading device (step 420). The host reading device has a display device that can display pages of the electronic book. The electronic book card and the host reading device can communicate in wired interface such as SD card, USB card, and a non wired interface such as Bluetooth, WiFi, infrared, etc. The configuration of the display device on the host reading device is next received by the electronic book card (step 430). The display configuration can be automatically transmitted from the host reading device to the electronic book card. The electronic book card can also prepare a few sample images having different resolution and other display conditions. The optimal display configuration can also be obtained by the user by manually selecting an image among different sample images when they are displayed on the display device.

Page images incorporating the content of the electronic book are then produced according to the configuration of the display device (step 440). The number of characters per page is dependent on the resolution and the size of the display device, which in turn determines the number of page images to contain all the content in the electronic book. It should be noted that the page images are dynamically produced and are not pre-stored. High frequency patterns can be added to the backgrounds of the page images to make it difficult for unauthorized storage and use of the page images (step 450). The page images are produced in a sequence as specified by the content of the electronic book. The page images are sent to the host reading device. In a sequence the page images as defined by the electronic book (step 460). The page images can be displayed in sequence on the display of the host reading device (step 470) which allows the electronic book to be read by the user.

It is understood that the disclosed circuit and methods are compatible with other configurations of the electronic modules and functional designs without deviation from the spirit of the present specification. For example, the interface between the host reading device and the electronic book card can include other standards in addition to the examples described above. The book page images can be provided in different image formats from the ones described as long as they can be read by the host reading device.

What is claimed is:

1. An electronic book card, comprising:
a communication interface configured to communicate with a host reading device having a display device configured to display images in a display configuration, wherein the communication interface is configured to receive the display configuration from the host reading device;
a non-volatile memory configured to store content of an electronic book; and
a data processing unit in communication with the communication interface and the non-volatile memory, wherein the data processing unit is configured to generate page images in accordance with the display configuration of the display device, wherein the page images incorporate the content of the electronic book.

2. The electronic book card of claim 1, wherein the data processing unit is configured to dynamically generate page images in accordance with the resolution of the display device on the host reading device.

3. The electronic book card of claim 2, wherein the content of the electronic book is not stored in page layouts in the non-volatile memory.

4. The electronic book card of claim 2, wherein the data processing unit is configured to superimpose a background image on the content of the electronic book to produce the page images.

5. The electronic book card of claim 4, wherein the background image comprises at least one of dots, textures, or wavy lines.

6. The electronic book card of claim 1, wherein the content of the electronic book comprises at least one of text, a figure, or a table.

7. The electronic book card of claim 1, further comprising:
a non-volatile memory controller configured to retrieve the content of the electronic book from the non-volatile memory.

8. The electronic book card of claim 7, further comprising:
a micro controller core configured to control the communication among the communication interface, the non-volatile memory controller, and the data processing unit.

9. The electronic book card of claim 8, further comprising a micro controller unit that integrates the data processing unit, the non-volatile memory controller, and the micro controller core in an integrated circuit.

10. The electronic book card of claim 9, wherein at least one of the communication interface or the non-volatile memory is embedded in the micro controller unit.

11. The electronic book card of claim 1, wherein the data processing unit is configured to automatically receive the configuration of the display device from the host reading device after the communication interface establishes communication with a host reading device having a display device.

12. The electronic book card of claim 1, wherein the data processing unit is configured to send a plurality of sample page images to the host reading device, each sample image compatible with a different display configuration, wherein the display device on the host reading device is configured to display the plurality of sample page images to allow a reader to select one of the sample page images having display configuration suitable for the display device, wherein the data processing unit is configured to generate the page images in response to the sample image selected by the user.

13. The electronic book card of claim 1, wherein the communication interface is compatible with a standard selected from Secure Digital (SD) card, universal standard bus (USB) memory stick, CompactFlash card, SmartMedia card, Memory Stick, and Multimedia Card.

14. The electronic book card of claim 1, wherein the host reading device comprises an image frame, a desktop computer, a laptop computer, a tablet computer, a mobile phone, a GPS receiver, a gaming machine, or an electronic book reader.

15. A method for providing electronic books, comprising:
storing content of an electronic book in a non-volatile memory in an electronic book card;
establishing communication between a communication interface in the electronic book card and with a host reading device, wherein the host reading device comprises a display device configured to display images in a display configuration;
receiving the display configuration by the communication interface from the host reading device;
generating page images by a data processing unit in the electronic book card in accordance with the display configuration, wherein the data processing unit is configured to incorporate the content of the electronic book in the page images; and
sending the page images from the electronic book card to the host reading device through the communication interface to allow the page images to be displayed on the display device.

16. The method of claim 15, further comprising:
dynamically generating page images by the data processing unit in accordance with the resolution of the display device.

17. The method of claim 16, wherein the content of the electronic book is not stored in page layouts in the non-volatile memory.

18. The method of claim 16, wherein the step of generating page images comprises superimposing a background to the content of the electronic book to produce the page images.

19. The method of claim 15, further comprising:
automatically receiving the configuration of the display device by the data processing unit from the host reading device after the step of establishing communication.

20. The method of claim 15, further comprising:
sending a plurality of sample page images from the electronic book card to the host reading device, each sample image compatible with a different display configuration to display the plurality of sample page images;
allowing a reader to select one of the sample page images having display configuration suitable for the display device; and
generating the page images in response to the sample image selected by the user.

21. The method of claim 15, wherein the communication interface is compatible with a standard selected from Secure Digital (SD) card, universal standard bus (USB) memory stick, CompactFlash card, SmartMedia card, Memory Stick, and Multimedia Card.
